(19) United States
(12) Patent Application Publication
(10) Pub. No.: US 2005/0163235 A1
(43) Pub. Date: Jul. 28, 2005

(54) Method and apparatus for improving error rates in multi-band ultra wideband communication systems

(76) Inventors: Shaomin Samuel Mo, Monmouth Junction, NJ (US); Robert S. Fish, Gillette, NJ (US); Alexander D. Gelman, Smallwood, NY (US)

Correspondence Address: RATNERPRESTIA, P O BOX 980, VALLEY FORGE, PA, 19482-0980, US

(21) Appl. No.: 10/766,787

(22) Filed: Jan. 28, 2004

(51) Int. Cl. H04L 27/28; H04K 1/10

(52) U.S. Cl. 375/260

(57) ABSTRACT

Methods, systems, and apparatus for use in a communication system utilizing multiple bands to improve transmission error rates are disclosed. Error rates are improved by mapping a portion of an input bit stream within a data stream to first and second bands of the multiple bands, transmitting the portion of this bit stream in the first and second bands, receiving bit streams in the first and second bands corresponding to the portion of the bit stream, demapping the first and second bands, and processing the first and second band bit streams to yield the original portion of the input bit stream.

### FIELD OF THE INVENTION

The present invention relates to the field of ultra wideband communication systems and, more particularly, to methods and apparatus for improving error rates of data streams transmitted using such communication systems.

### BACKGROUND OF THE INVENTION

Ultra Wideband (UWB) technology, which uses base-band pulses of very short duration to spread the energy of transmitted signals very thinly from near zero to several GHz, is presently in use in military applications. Commercial applications will soon become possible due to a recent Federal Communications Commission (FCC) decision that permits the marketing and operation of consumer products incorporating UWB technology.

Presently, UWB is under consideration by the Institute of Electrical and Electronic Engineers (IEEE) as an alternative physical layer technology. See IEEE Standard 802.15.3a, which is designed for home wireless audio/video systems. This standard sets forth that UWB systems should operate well in an environment of at least four uncoordinated piconets and that packet error rates should be below 8%. Piconets, e.g., personal area networks (PANs), are formed when at least two devices, such as a portable PC and a cellular phone, connect.

Packet error rates (PER) can be attributed to narrow band interference (NBI) and to collision among communication bands of multiple uncoordinated piconets. “Multi-band” modulation technologies have been developed to deal with NBI. FIG. 1 depicts a prior art multi-band mapping scheme in which a frequency band is divided into multiple sub-bands (i.e., band-1 to band-N) utilizing a waveform in each sub-band. A symbol-to-band mapping component in a transmitter maps a data stream to the multi-bands for transmission and a band-to-symbol mapping component in a receiver reverses the mapping.

An advantage of multi-band systems is their ability to work in environments with NBI. When NBI is detected in a receiver, a transmitter in a multi-band system automatically shuts down the corresponding bands on which the NBI occurred to reduce the effects of NBI.

Shutting down a band in a multi-band UWB communication system, however, results in the transmission of more data in the remaining bands. The increase in data being transmitted in these remaining bands may elevate their power spectral density (PSD) and/or transmission power to unacceptable levels. In addition, detecting band interference in a receiver and shutting down those bands in a transmitter necessitates complex synchronization, which may cause implementation difficulties.

There is an ever-present desire for improved communication systems such as multi-band UWB communication systems with reduced error rates. Accordingly, there is a need for improved methods, apparatus, and systems to improve error rates in multi-band UWB communication systems that are not subject to the above limitations. The present invention fulfils this need among others.

### SUMMARY OF THE INVENTION

The present invention is for use in a communication system utilizing multiple bands to improve transmission error rates. Error rates are improved by mapping a portion of an input bit stream within a data stream to first and second bands of the multiple bands, transmitting the portion of this bit stream in the first and second bands, receiving bit streams in the first and second bands corresponding to the portion of the bit stream, demapping the first and second bands, and processing the first and second band bit streams to yield the original portion of the input bit stream.

### BRIEF DESCRIPTION OF THE DRAWINGS

The invention is best understood from the following detailed description when read in connection with the accompanying drawings, with like elements having the same reference numerals. Included in the drawings are the following figures:

FIG. 1 is a block diagram of a prior art mapping scheme;

FIG. 2 is a block diagram of an exemplary mapping scheme in accordance with the present invention;

FIG. 3 is a block diagram on an alternative exemplary mapping scheme in accordance with the present invention;

FIG. 4 is a block diagram of a simulation configuration for determining the effectiveness of systems in accordance with the present invention;

FIGS. 5A and 5B are illustrations depicting a two frame transmission mapping scheme and a single frame transmission mapping scheme, respectively, in accordance with the present invention;

FIGS. 6A and 6B are graphs depicting bit error rate (BER) and packet error rate (PER), respectively, versus signal-to-noise ratio (SNR) with a 1/3 collision rate and without collision for a single frame transmission technique in accordance with the present invention;

FIGS. 7A and 7B are graphs depicting bit error rate (BER) and packet error rate (PER), respectively, versus signal-to-noise ratio (SNR) with a 1/4 collision rate and without collision for a single frame transmission technique in accordance with the present invention;

FIGS. 8A and 8B are graphs depicting bit error rate (BER) and packet error rate (PER), respectively, versus signal-to-noise ratio (SNR) with a 1/5 collision rate and without collision for a single frame transmission technique in accordance with the present invention;

FIGS. 9A and 9B are graphs depicting bit error rate (BER) and packet error rate (PER), respectively, versus signal-to-noise ratio (SNR) with a 1/6 collision rate and without collision for a single frame transmission technique in accordance with the present invention;

FIGS. 10A and 10B are graphs depicting bit error rate (BER) and packet error rate (PER), respectively, versus signal-to-noise ratio (SNR) with a 1/7 collision rate and without collision for a single frame transmission technique in accordance with the present invention;

FIGS. 11A and 11B are graphs depicting bit error rate (BER) and packet error rate (PER), respectively, versus signal-to-noise ratio (SNR) with a 1/8 collision rate and without collision for a single frame transmission technique in accordance with the present invention;

FIGS. 12A and 12B are graphs depicting bit error rate (BER) and packet error rate (PER), respectively, versus signal-to-noise ratio (SNR) with a 1/3 collision rate and without collision for a two frame transmission technique in accordance with the present invention;

FIGS. 13A and 13B are graphs depicting bit error rate (BER) and packet error rate (PER), respectively, versus signal-to-noise ratio (SNR) with a 1/4 collision rate and without collision for a two frame transmission technique in accordance with the present invention;

FIGS. 14A and 14B are graphs depicting bit error rate (BER) and packet error rate (PER), respectively, versus signal-to-noise ratio (SNR) with a 1/5 collision rate and without collision for a two frame transmission technique in accordance with the present invention;

FIGS. 15A and 15B are graphs depicting bit error rate (BER) and packet error rate (PER), respectively, versus signal-to-noise ratio (SNR) with a 1/6 collision rate and without collision for a two frame transmission technique in accordance with the present invention;

FIGS. 16A and 16B are graphs depicting bit error rate (BER) and packet error rate (PER), respectively, versus signal-to-noise ratio (SNR) with a 1/7 collision rate and without collision for a two frame transmission in accordance with the present invention;

FIGS. 17A and 17B are graphs depicting bit error rate (BER) and packet error rate (PER), respectively, versus signal-to-noise ratio (SNR) with a 1/8 collision rate and without collision for a two frame transmission technique in accordance with the present invention;

FIG. 18 is a block diagram of an exemplary communication system in accordance with the present invention;

FIG. 19 is a flow chart of exemplary steps for transmitting and receiving data in accordance with the present invention; and

FIG. 20 is a flow chart of alternative exemplary steps for transmitting and receiving data in accordance with the present invention.

### DETAILED DESCRIPTION OF THE INVENTION

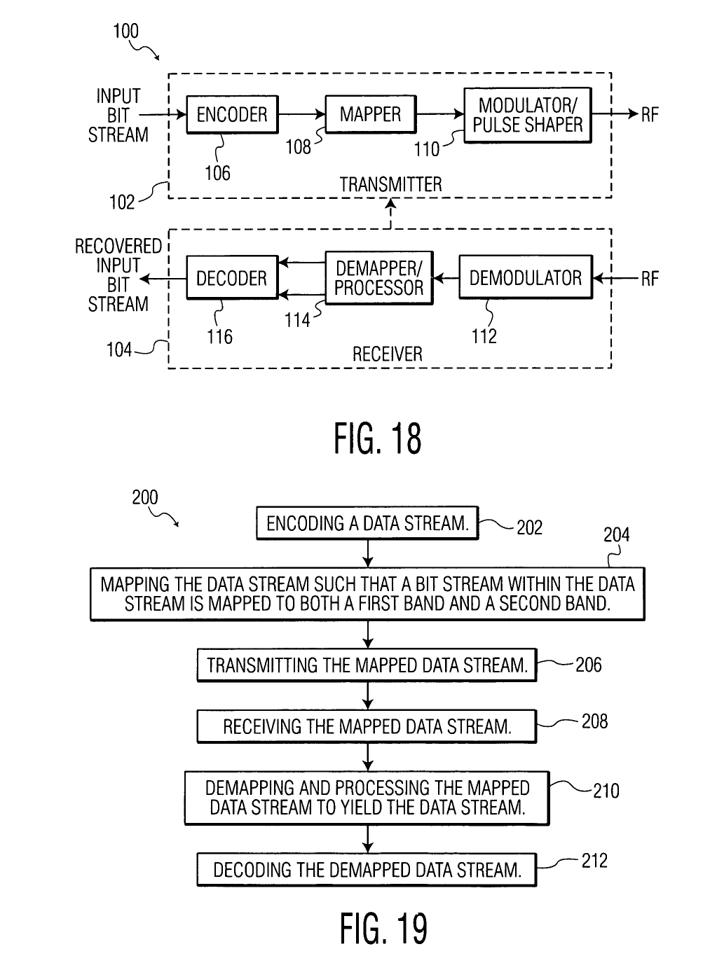

FIG. 18 conceptually represents an exemplary UWB communication system 100 with improved transmission error rates in accordance with the present invention. One or more blocks within the illustrated communication system 100 can be performed by the same piece of hardware or module of software. It should be understood that embodiments of the present invention may be implemented in hardware, software, or a combination thereof. In such embodiments, the various component and steps described below would be implemented in hardware and/or software.

In general overview, a UWB multi-band transmitter 102 transmits a convolutionally encoded data stream for receipt by a UWB multi-band receiver 104. In the transmitter 102, an input bit stream is applied to an encoder 106 that encodes the input bit stream to create an original data stream of symbols (also a bit stream). A mapper 108 maps the symbols (i.e., portions of the data/bit stream) to the bands of the multi-band UWB communication system such that each symbol is mapped to two distinct bands. A modulator/pulse shaper 110 modulates and prepares the bands containing symbols for transmission by the transmitter 102.

In the UWB multi-band receiver 104, a demodulator 112 demodulates the modulated bands containing symbols. A demapper 114 demaps the demodulated bands to recover the original data stream. A decoder 116 decodes the original data stream(s) to yield the input bit stream.

The components of the UWB communication system 100 are now described in detail. The encoder 106 encodes the input bit stream using convolutional encoding, which is a known forward error correction (FEC) technique. In an exemplary embodiment, a cyclic redundancy check (CRC) value is calculated based on the input bit stream and is attached to corresponding data packets for transmission. In addition, the input bit stream may be randomized and interleaved in a conventional manner during the encoding.

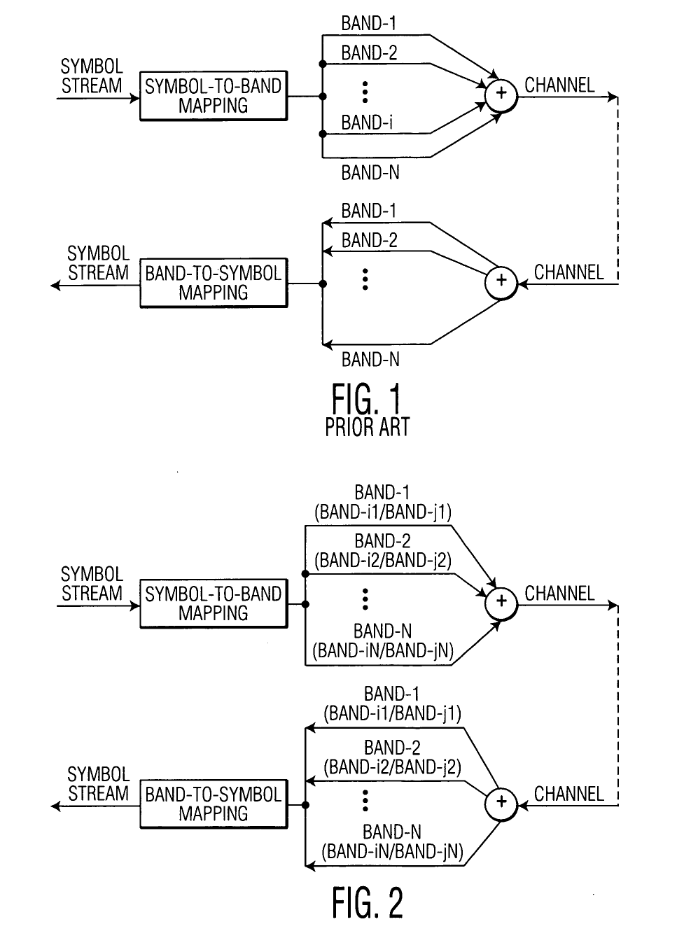

The mapper 108 maps the symbols provided by the encoder 106 to bands of the multi-band UWB communication system. As described in further detail below, the mapper 108 may map the symbols using a single frame transmission technique or a multiple frame transmission technique such as a two frame transmission technique. FIG. 2 depicts an exemplary embodiment for mapping the data stream of symbols to the multiple bands using a two frame transmission technique. The symbols are mapped to the multiple bands during a first transmission in a first order (represented by band-i1 to band-iN before the forward slash “/”) and to the bands during a second transmission in a second order (represented by band-j1 to band-jN after the forward slash), where the first and second orders are different. In an exemplary embodiment, the first and second transmission always occur for each symbol. In an alternative exemplary embodiment, the second transmission only occurs if a packet containing a symbol in the first transmission includes errors (e.g., based on a CRC check), which is described in further detail below. Demapping the symbols from the multiple bands in accordance with the two frame transmission technique is also described below.

FIG. 5A illustrates the band mapping for a four-band system in which every fourth band is corrupt due to collision (where identifiers for corrupt symbols/packets are enclosed in brackets). During a first transmission (i.e., at a first frame time illustrated by the top row of FIG. 5A) the symbols are assigned to the bands in a repeating numerical sequence beginning with numeral one and during a second transmission (i.e., at a second frame time illustrated by the bottom row of FIG. 5A) the symbols are assigned to the bands in a repeating numerical sequence beginning with the numeral three. Thus, each symbol/packet is transmitted in two different bands. Accordingly, if one of the bands includes a corrupt symbol/packet it is possible that a corresponding symbol/packet from another band in another transmission is not corrupt.

In an exemplary embodiment, each symbol is included in both the first and second transmissions. In an alternative exemplary embodiment, a symbol is only included in the second transmission if an indicator is received from the receiver 104 (FIG. 1) indicating that a symbol/packet of the first transmission is corrupt. In accordance with this embodiment, the transmitter 102 (FIG. 1) is configured to receive an error detection signal from the receiver 104 and to configure the mapper 108 to map symbols in the second transmission responsive to receipt of the error detection signal.

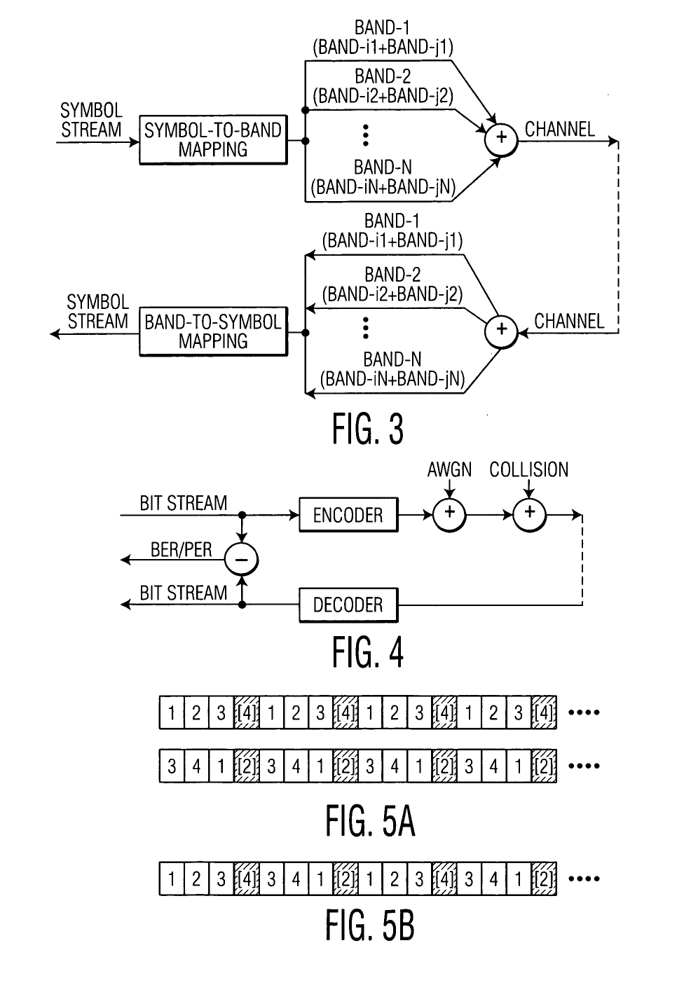

FIG. 3 depicts an alternative exemplary embodiment for mapping the data steam of symbols to the multiple bands. As depicted in FIG. 3, the symbols are mapped to the multiple bands using a single frame transmission technique. In the single frame transmission technique, symbols are mapped in a first order (represented by band-i1 to band-iN before the plus sign “+”) followed by a second order (represented by band-j1 to band-jN after the plus sign), where the first and second orders are different. Demapping the symbols from the multiple bands in accordance with this embodiment is described below.

The single frame transmission technique is beneficial in audio/video stream systems in which retransmission may adversely affect quality of service (QoS) due to variable delay jitter and variable bandwidth requirements. A single frame transmission eliminates uncertainty in jitter and bandwidth while improving symbol reliability.

FIG. 5B illustrates the band mapping for a four-band system in which every fourth band is corrupt due to collision (where identifiers corresponding to corrupt symbols/packets are bracketed). During a single frame transmission, the symbols are assigned to the bands alternating between a repeating numerical sequence beginning with the numeral one and a repeating numerical sequence beginning with the numeral three. Thus, the same symbol/packet are transmitted in different bands in the same transmission, i.e., at the same frame time. Accordingly, if the symbol/packet in one of the bands is corrupt, it is possible that a corresponding symbol/packet from another band of the same transmission is not corrupt.

Referring back to FIG. 18, the modulator/pulse shaper 110 modulates the digital bits of the encoded symbol streams in the multi-bands onto carrier pulses for transmission from the transmitter 102, e.g., via radio frequencies (RF). In an exemplary embodiment the carrier pulses are UWB pulses. The transmitted encoded symbol streams in the multi-bands are received at the receiver 104 where the demodulator 112 demodulates them into digital bits to recover the encoded symbol streams in the multi-bands.

The demapper/processor 114 demaps the multi-band encoded symbol streams to form the original encoded stream of data symbols. FIG. 2 depicts an exemplary embodiment for mapping the multiple bands to an encoded data stream of symbols using a two frame transmission technique and FIG. 3 depicts an exemplary embodiment for mapping the multiple bands to an encoded data steam of symbols using a single frame transmission technique.

Referring back to FIG. 18, in an exemplary embodiment, the demapper/processor 114 passes two identical streams of symbols to the decoder 116, e.g., a first data stream corresponding to the first occurrence of each symbol and a second data steam corresponding to the second occurrence of each symbol. This effectively doubles the transmission power (and halves the transmission rate), thus increasing the signal-to-noise (SNR) ratio. In an alternative exemplary embodiment, a single stream of symbols is passed to the decoder, e.g., a first data stream corresponding the first occurrence of each symbol followed, as needed (e.g., due to corrupt packets), by a second data stream corresponding to the second occurrence.

The decoder 116 decodes the encoded data stream(s) received from the demapper/processor 114 to yield the original input bit stream. The decoder 118 reverses the encoding performed by the encoder 106. Where the encoder 106 encoded the input bit stream using a convolutional code, the decoder 118 is configured with a corresponding convolutional code to reverse the convolutional code introduced to the input bit stream by the encoder 106. Any randomizing and interleaving introduced by the encoder 106 is also reversed. A suitable decoder 116 for use in the present invention will be understood by those of skill in the art.

In an exemplary embodiment the decoder 116 treats the bit stream as noise-bearing data. For example, assume a symbol from a collision free band is 0.98 and a symbol from a band experiencing collision is −0.33. If only the band experiencing collision is used as in the case of prior art transmission systems, the symbol passed to the decoder is −0.33. In the present invention, however, the two symbols are combined for use by the decoder 116, e.g., 0.98+(−0.33)=0.65. In an exemplary embodiment, the decoder 116 has the ability to derive correct input from distorted data, e.g., through the use of a conventional slicer (not shown).

In an exemplary two frame transmission system in which the second frame is only sent if errors are detected in the first frame, the decoder 116 checks a CRC in each transmission frame. A CRC value calculated by the decoder 116 is compared with a transmitter-side CRC that is attached in the packet. If the CRCs match the packet is considered error free. If the CRCs are different, an error indicator is generated by the decoder 116 and passed from the receiver 104 to the transmitter 102 to request a second transmission.

FIG. 19 depicts a flow chart 200 of exemplary steps to improve transmission error rates in accordance with the present inventions. The exemplary steps are described with reference to the components of the exemplary UWB multi-band communication system 100 described above with reference to FIGS. 2, 3, 5A, 5B, and 18. The flow chart 200 is applicable to single frame transmission techniques and to multiple frame transmission techniques in which the multiple frames are always transmitted.

At block 202, the encoder 106 encodes an input bit stream to produce a data stream of symbols. In an exemplary embodiment the encoder 106 within the transmitter 102 encodes the bit stream using a convolutional code. Exemplary z-transform polynomials for generating the convolutional code are set forth below in equation 3.

At block 204, the mapper 108 maps the data steam such that a portion of the input bit stream within the data stream is mapped to both a first band and a second band. As described above, the portion of the bit stream may be mapped to two distinct bands within a single transmission frame or to different bands in each of two distinct transmission frames.

At block 206, the transmitter 102 transmits an encoded data stream over the multiple bands according to the mapping introduced at block 204 and, at block 208, the receiver 104 receives the encoded data stream over the multiple bands. In an exemplary embodiment, the received encoded data stream includes damaged and undamaged bits in which the damaged bits are received in frequency bands that are corrupt due to collision.

At block 210, the demapper/processor 114 demaps the received encoded data stream from the multiple bands and processes the demapped encoded data stream to yield the original data stream. The demapper/processor 114 effectively reverses the mapping performed by the mapper 108 and recovers symbols in corrupt bands to yield the original data stream. In an exemplary embodiment, the demapper/processor 114 generates a first stream of symbols from the first occurrence of each symbol and a second stream of symbols from the second occurrence of each symbol. Both the transmitter 102 and the receiver 104 operate according to a fixed protocol in order to identify duplicate transmissions.

At block 212, the decoder 118 processes the first and second streams of symbols and reverses the encoding introduced by the encoder 106 to recover the original input bit stream. In an exemplary embodiment, the decoder combines the first and second streams of symbols by adding the analog representation of the streams together. The decoder 118 processes the combined symbol values to derive the original input bit stream.

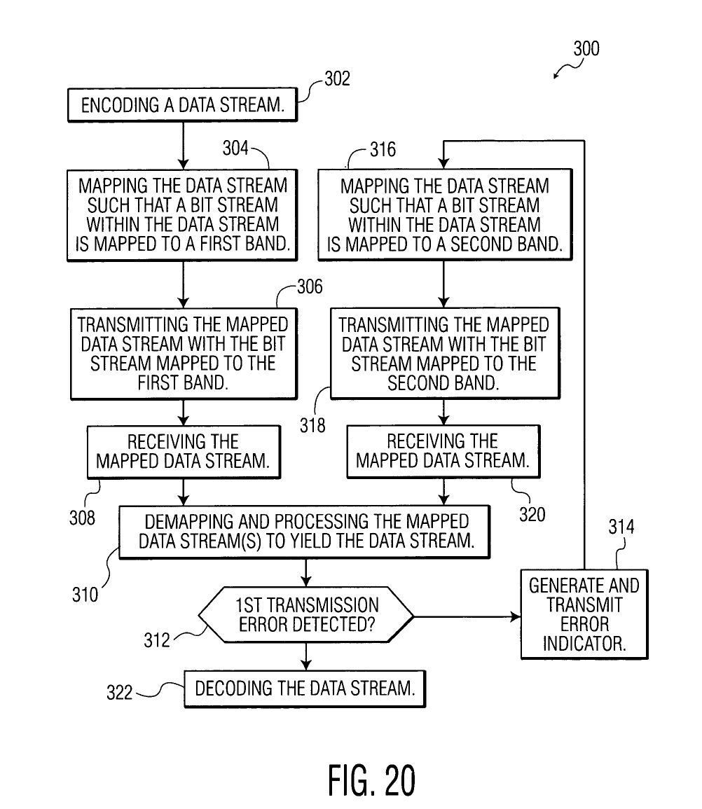

FIG. 20 depicts a flow chart 300 of alternative exemplary steps to improve transmission error rates in accordance with the present inventions. The exemplary steps are described with reference to the components of the exemplary UWB multi-band communication system 100 described above with reference to FIGS. 2, 3, 5A, 5B, and 18. The flow chart 300 is applicable to two frame transmission techniques in which the transmission of the second frame is contingent the detection of an error in the first transmission.

At block 302, the encoder 106 encodes an input bit stream to produce a data stream of symbols.

At block 304, the mapper 108 maps the data stream to a first transmission in a first mapping order such that a portion of a bit stream within the data stream is mapped to a first band of a multi-band communication system.

At block 306, the transmitter 102 transmits the mapped data stream with the bit stream mapped to the first band and, at block 308, the receiver 104 receives this mapped data stream.

At block 310, the demapper/processor 114 demaps and processes the received data stream(s) to yield the original data stream. A received data stream corresponding to a first transmission is demapped and processed to yield the original data stream and, contingent on the detection of errors at block 312, a second transmission is also demapped and processed to produce the original data stream.

At block 312, a decision is made regarding the presence of errors in the first transmission frame. If an error is detected in the first transmission frame (e.g., using a CRC check), the receiver 104 informs the transmitter 102 of the detected error and processing proceeds at block 314 for a second transmission frame. Thus, two received data frames are demapped and processed at block 310. Otherwise, if errors are not detected, processing proceeds to block 322 for decoding with only the first transmission frame being processed at block 310.

At block 314, the receiver 104 generates an error indicator and transmits the indicator to the transmitter 102.

At block 316, which is performed if an error is detected at block 312, the mapper 108 in the transmitter 102 maps the data stream to a second transmission in a second mapping order such that the portion of the bit stream within the data stream mapped to the first band at block 304 is mapped to a second band that is distinct from the first band.

At block 318, the transmitter 102 transmits the mapped data stream with the bit stream mapped to the second band and, at block 320, the receiver 104 receives this mapped data stream for processing at block 310.

At block 322, which is performed after the first transmission in the absence of error detection in block 312 and after the second transmission in the presence of a detected error, the decoder 116 processes the transmission(s) to recover the original input bit stream.

Simulations are now described for the above embodiments. The simulations assume that interleaving changes errors caused by collision into isolated symbol errors. The configuration of the simulations is shown in FIG. 4. The bit error rate (BER) is the result of a comparison between a bit stream into an encoder and a bit stream out of a decoder. The encoder z-transform polynomials are shown in equations 3.
g₁=1+z+z³+z⁵
g₂=1+z²+z³+z⁴+z⁵ (3)
The simulation includes the following parameters:
A packet size of 2048 Kbyte, or 2048*8 Kbit.
There are 10000 packets of data in each simulation.
The offset of sub-band mapping is 2, as shown in FIG. 5A. Thus, if logical block K is transmitted on sub-band L on the first transmission, logical K+2 is transmitted on the same sub-band on the second transmission. It is similar for the case of a single frame transmission technique as shown in FIG. 5B.

The collisions are evenly distributed over the bit stream. Collision rates of 1/3, 1/4 (as shown in FIGS. 5A and 5B), 1/5, 1/6, 1/7, and 1/8 are used.

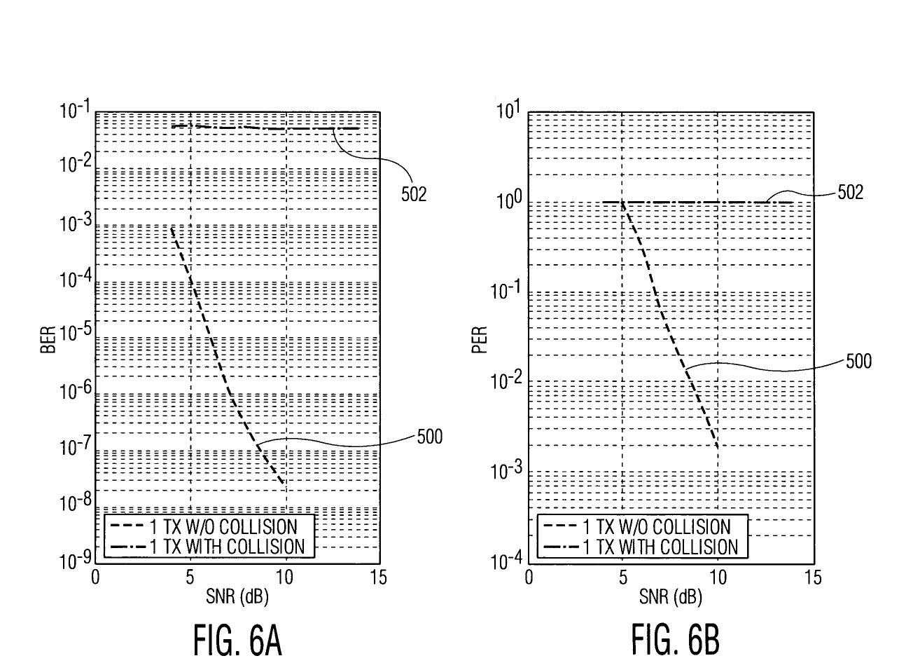

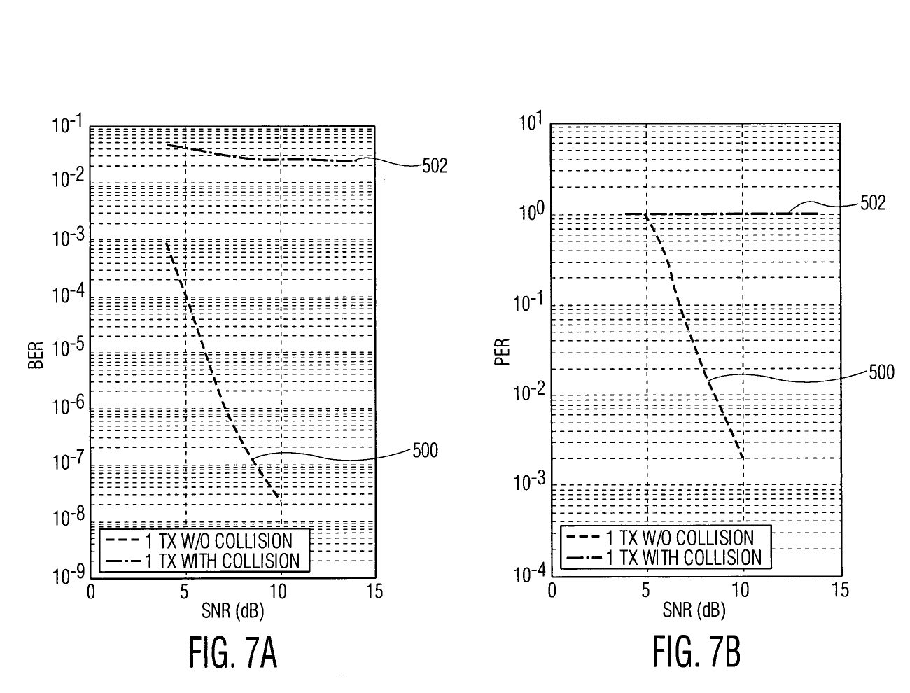

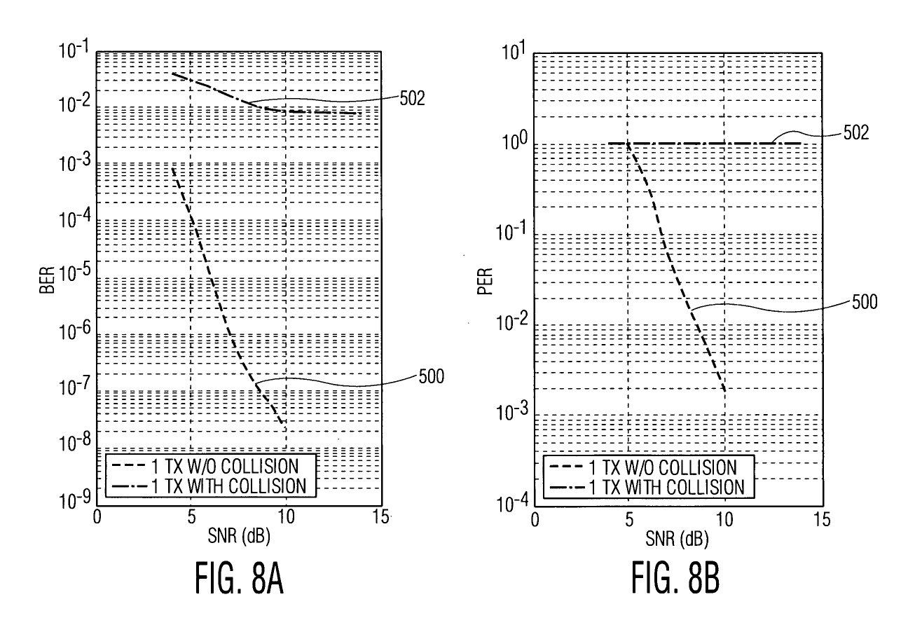

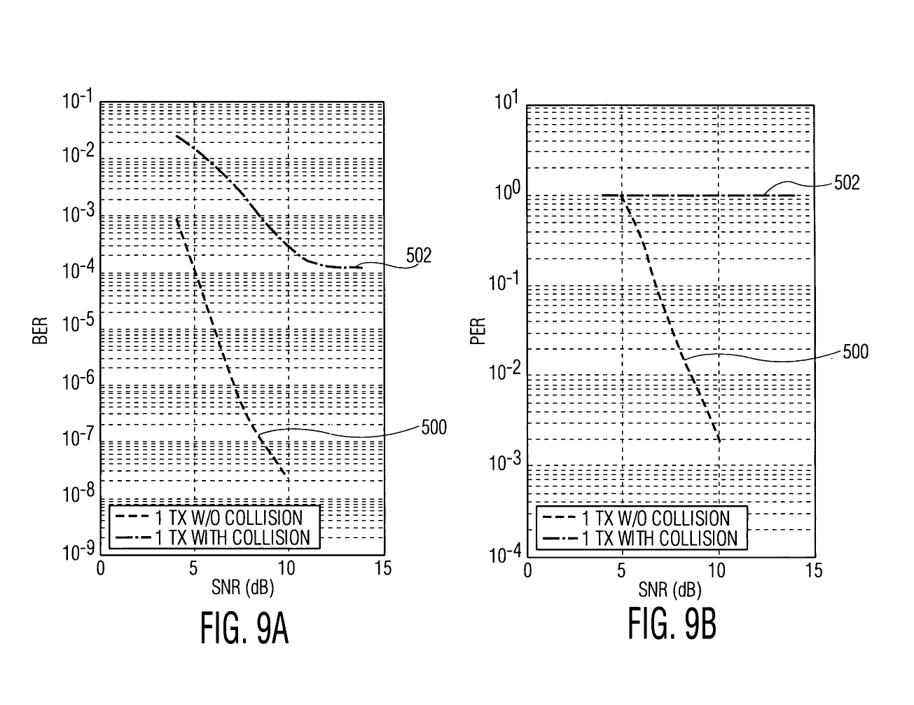

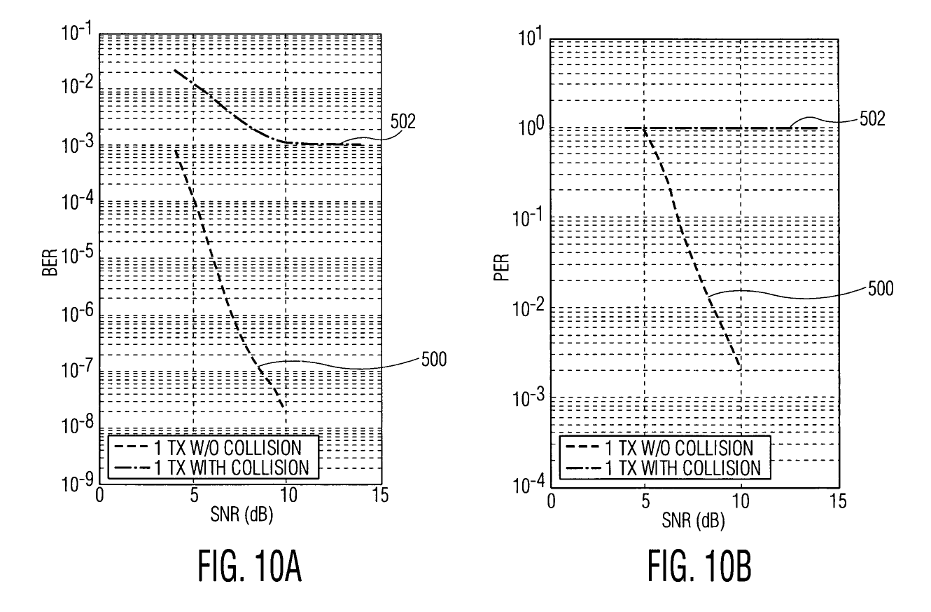

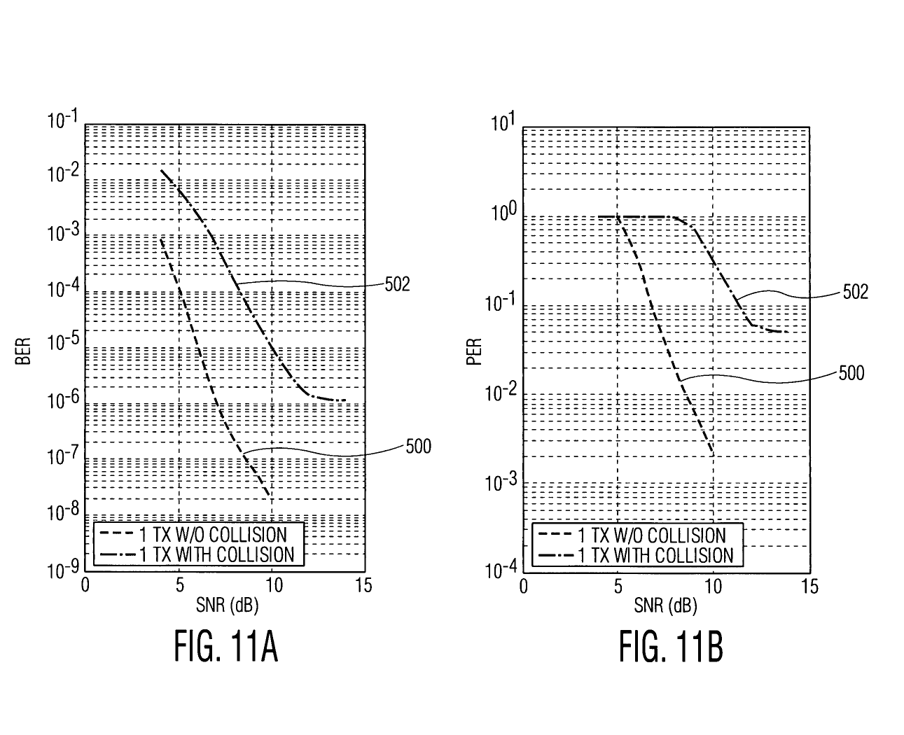

FIGS. 6 to 11 (with each figure having an “A” designation depicting bit error rates and each figure having a “B” designation depicting packet error rates) depict results using a single frame transmission technique for:
Single frame transmission with only Additive White Gaussian Noise (AWGN), represented by 1 tx w/o collision line 500.
Single frame transmission with both AWGN and collision, represented by 1 tx with collision line 502.

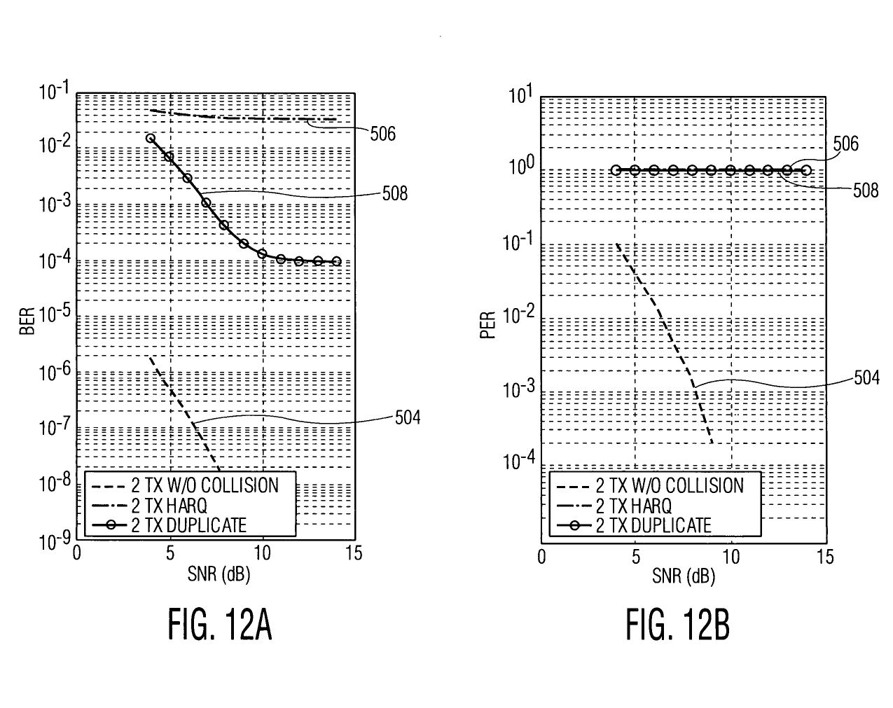

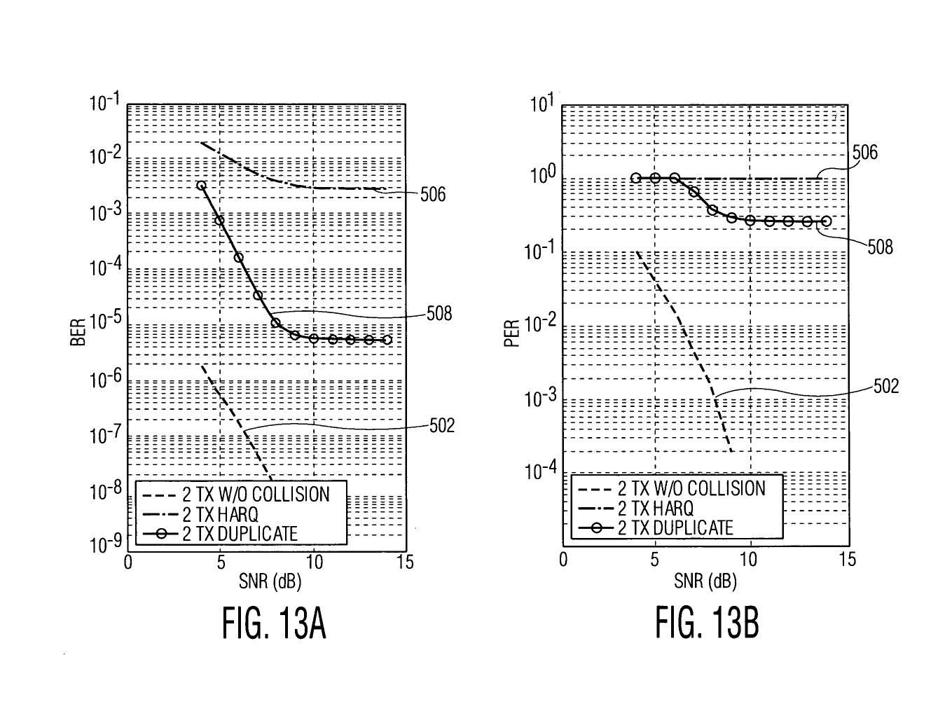

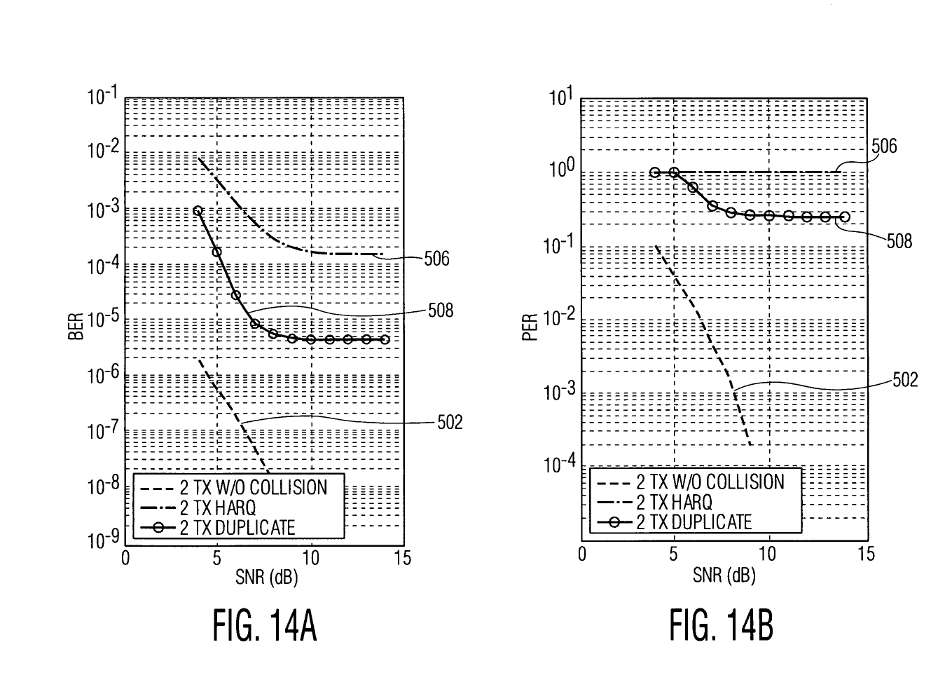

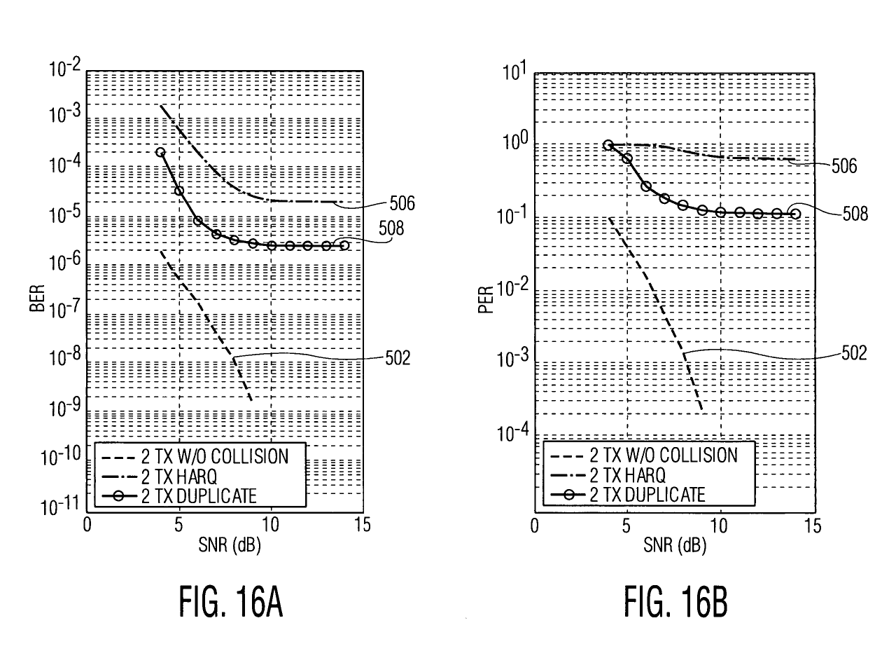

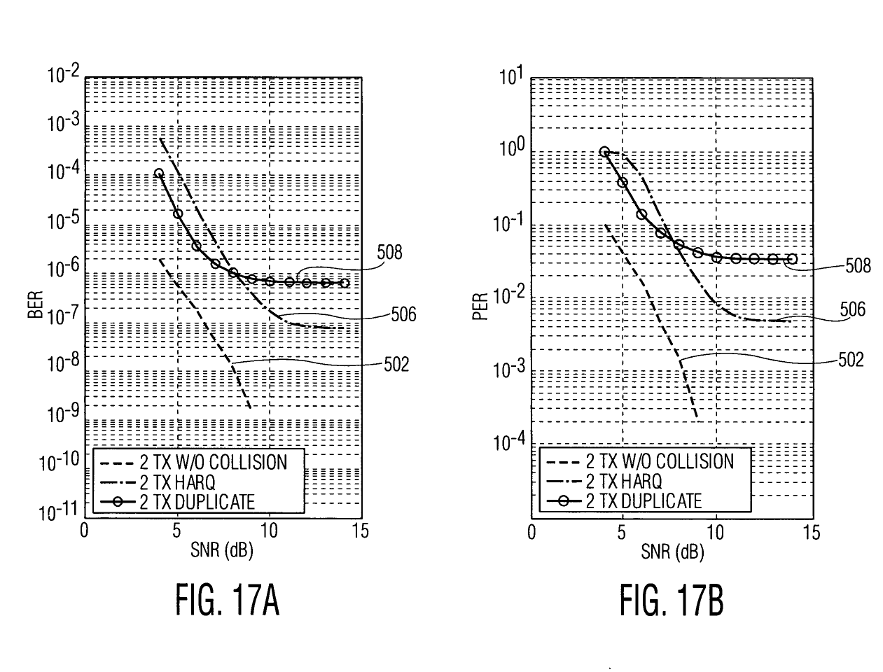

FIGS. 12 to 17 (with each figure having an “A” designation depicting bit error rates and each figure having a “B” designation depicting packet error rates) depict results for comparison using a two frame transmission technique for:
Two frame transmission without collision using a conventional hybrid automatic repeat request (HARQ), represented 2 tx w/o collision line 504. HARQ corrects errors due to unreliable channel conditions based on a known automatic repeat request (ARQ) scheme together with a forward error correction (FEC) technique.
Two frame transmission with both AWGN and collision using conventional HARQ, represented by 2 tx HARQ line 506.
Two frame transmission in accordance with the present invention with both AWGN and collision, represented by 2 tx duplicate line 508.

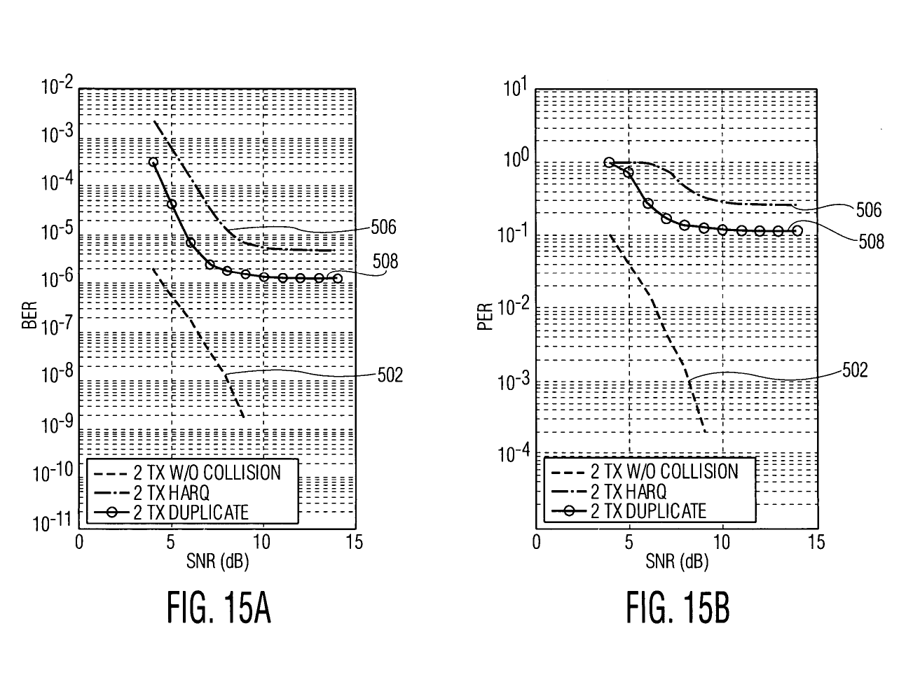

The simulation results show that:
A high collision rate has a significant impact on performance, shown by 1× with collision lines 502. As shown, the packet error rate (PER) is almost 100% when the collision rate is higher than 1/7, see FIGS. 6B, 7B, 8B, 9B, and 10B;
Using conventional HARQ, no improvement in PER is offered when the collision rate is higher than 1/6, shown by 2 tx HARQ lines 506 in FIGS. 12B, 13B, and 14B. Only when the collision rate is below 1/6, are improvement noticeable as shown in FIGS. 15B, 16B, and 17B; and
Using the proposed multiple symbol-to-band mapping in accordance with the present invention, performance improvement can be seen even when collision rates are as high as 1/3 as shown by the 2 tx duplicate lines 508 in FIGS. 12-17.

The present invention provides for the use of multiple symbol-to-band mappings to increase overall symbol reliabilities for transmissions. Simulation results depict improved performance over prior art techniques, especially in an environment with high collision rates. The scheme can be applied to essentially any systems with time-hopping, frequency-hopping and combined-time-frequency-hopping.

In an exemplary time-hopping system, in a first transmission frame (or a first part of a single transmission frame), symbols may be time shifted using a first time-hopping scheme and, in a second transmission frame (or a second part of the single transmission frame), these symbols may be time shifted using a second time-hopping scheme such that the first and second occurrence of the symbols are in different time slots. A corrupt symbol in one time slot corresponding to the first transmission (or first part of a single transmission) may be combined with a corresponding non-corrupt symbol in another time slot in the second transmission (or second part of the single transmission). Likewise, in an exemplary frequency-hopping system, in a first transmission frame, symbols may be frequency shifted using a first frequency-hopping scheme and, in a second transmission frame, symbols may be frequency shifted using a second frequency-hopping scheme such that the first and second occurrence of the symbols are in different frequency bands. A corrupt symbol in one frequency band corresponding to the first transmission (or first part of a single transmission) may be combined with a corresponding non-corrupt symbol in another frequency band in the second transmission (or second part of the single transmission). A combined time-frequency-hopping scheme will be understood by those of skill in the art from the above description.

Although the invention has been described in terms of a UWB multi-band transmitter 102 (including an encoder 106, a mapper 108, and a modulator/pulse shaper 110) and a UWB multi-band receiver 104 (including a demodulator 112, demapper/processor 114, and a decoder 116) it is contemplated that the invention may be implemented in software on a computer (not shown), such as a general purpose computer, special purpose computer, digital signal processor, microprocessor, microcontroller, or essentially any device capable of processing digital signals. In this embodiment, one or more of the functions of the various components may be implemented in software that controls the computer. This software may be embodied in a computer readable carrier, for example, a magnetic or optical disk, a memory-card or an audio frequency, radio-frequency, or optical carrier wave.

In addition, although the invention is illustrated and described herein with reference to specific embodiments, the invention is not intended to be limited to the details shown. Rather, various modifications may be made in the details within the scope and range of equivalents of the claims and without departing from the invention.

1. A method for use in a communication system utilizing multiple bands to improve error rates in the transmission of a data stream to a receiver, the method comprising the steps of:
mapping a bit stream within the data stream to a first band of the multiple bands;
mapping the bit stream to a second band of the multiple bands, wherein the first and second bands are non-overlapping; and
transmitting the bit stream in the first band and the bit stream in the second band for receipt by the receiver.

2. The method of claim 1, wherein the method is for use in an Ultra Wideband (UWB) communication system which utilizes a plurality of UWB multi-bands and wherein the transmitting step comprises the steps of:
transmitting the bit stream in the first band via a first UWB multi-band of the plurality of UWB multi-bands and the bit stream in the second band via a second UWB multi-band of the plurality of UWB multi-bands.

3. The method of claim 1, further comprising the step of:
receiving a received error indicator corresponding to the bit stream in the first band, wherein the bit stream is mapped to the second band and transmitted in the second band only responsive to receipt of the received error indicator.

4. The method of claim 1, wherein the transmitting step comprises the step of:
transmitting the bit stream in the first band and the second band substantially concurrently.

5. The method of claim 1, wherein the bit stream is mapped to the first band in a frame time and wherein the step of mapping the bit stream to the second band comprises the steps of:
mapping the bit stream to the second band in the same frame time as the bit stream in the first band.

6. The method of claim 1, wherein the bit stream is mapped to the first band in a frame time and wherein the step of mapping the bit steam to the second band comprises the steps of:
mapping the bit stream to the second band in a subsequent frame time to the frame time in which the bit stream is mapped to the first band.

7. A method for use in a communication system utilizing multiple bands to improve error rates in a data stream received from a transmitter, the transmitter capable of mapping a portion of an input bit stream of a data stream to a first band of the multiple bands and the portion of the input bit stream to a second band of the multiple bands, the method comprising the steps of:
receiving a bit stream in the first band and an other bit stream in the second band, the received bit streams corresponding to the portion of the input bit stream;
demapping the first band including the received bit stream to obtain a first band bit stream corresponding to the input bit stream;
demapping the second band including the other bit stream to obtain a second band bit stream corresponding to the second bit stream; and
processing the first and second band bit streams to yield the portion of the input bit stream.

8. The method of claim 7, wherein the first and second band bit streams each include symbols and wherein the processing step comprises the step of:
combining symbols in the first band bit stream with corresponding symbols in the second band bit stream; and
processing the combined symbols to yield the portion of the input bit stream.

9. The method of claim 7, wherein the transmitter is configured to map the portion of the input bit stream to the second band responsive to an error detection signal and wherein the method further comprises the steps of:
detecting errors in the first band; and
generating the error detection signal for receipt by the transmitter responsive to the detected errors.

10. An apparatus for use in a communication system utilizing multiple bands to improve error rates in the transmission of a data stream to a receiver, the apparatus comprising:
a mapper configured to map a bit stream within the data stream to a first band of the multiple bands and to map the bit stream to a second band of the multiple bands, wherein the first and second bands are non-overlapping; and
a transmitter coupled to the mapper, the transmitter configured to transmit the bit stream in the first band and the bit stream in the second band for receipt by the receiver.

11. The apparatus of claim 10, wherein the transmitter is an Ultra Wideband (UWB) multi-band transmitter.

12. The apparatus of claim 10, wherein the mapper is further configured to receive a received error indicator corresponding to the bit stream in the first band and wherein the mapper only maps the bit stream to the second band for transmission by the transmitter responsive to receipt of the received error indicator.

13. The apparatus of claim 10, wherein the mapper is configured to map the bit stream to the first band in a frame time and to map the bit stream to the second band in the same frame time as the bit stream in the first band.

14. The apparatus of claim 10, wherein the mapper is configured to map the bit stream to the first band in a frame time and to map the bit stream to the second band in a subsequent frame time to the frame time in which the bit stream is mapped to the first band.

15. An apparatus for use in a communication system utilizing multiple bands to improve the reception of a data stream from a transmitter, the transmitter capable of mapping a portion of an input bit stream of a data stream to a first band of the multiple bands and the portion of the input bit stream to a second band of the multiple bands, the method comprising the steps of:
a receiver configured to receive a bit stream corresponding to the portion of the input bit stream in the first band and an other bits stream corresponding to the portion of the input bit stream in the second band;
a demapper coupled to the receiver, the demapper configured to demap the first band to obtain a first band bit stream corresponding to the bit stream and to demap the second band to obtain a second band bit stream corresponding to the first band bit stream; and
a processor coupled to the demapper, the processor configured to process the first and second band bit streams to yield the portion of the input bit stream.

16. The apparatus of claim 15, wherein the first and second input bit streams each include symbols and wherein the processor is further configured to combine symbols in the first input bit stream with corresponding symbols in the second input bit stream and to process the first and second input bit streams to yield the portion of the input bit stream.

17. The apparatus of claim 16, wherein the transmitter maps the portion of the input bit steam to the second band responsive to an error detection signal and wherein the processor is further configured to detect errors in the first band and to generate the error detection signal for receipt by the transmitter responsive to the detected error.

18. A system for use in a communication system utilizing multiple bands to improve error rates in the transmission of a data stream to a receiver, the system comprising:
means for mapping a bit stream within the data stream to a first band of the multiple bands;
means for mapping the bit stream to a second band of the multiple bands, wherein the first and second bands are non-overlapping; and
means for transmitting the bit stream in the first band and the bit stream in the second band for receipt by the receiver.

19. The system of claim 18, further comprising:
means for receiving a received error indicator corresponding to the bit stream in the first band, wherein the bit stream is mapped to the second band and transmitted in the second band only responsive to receipt of the received error indicator.

20. A system for use in a communication system utilizing multiple bands to improve error rates in a data stream received from a transmitter, the transmitter capable of mapping a portion of an input bit stream of a data stream to a first band of the multiple bands and the portion of the input bit stream to a second band of the multiple bands, the system comprising:
means for receiving a bit stream in the first band and an other bit stream in the second band, the received bit streams corresponding to the portion of the input bit stream;
means for demapping the first band including the received bit stream to obtain a first band bit stream corresponding to the input bit stream;
means for demapping the second band including the other bit stream to obtain a second band bit stream corresponding to the second bit stream; and
means for processing the first and second band bit streams to yield the portion of the input bit stream.

21. The system of claim 20, wherein the means for processing comprises:
means for combining symbols in the first band bit stream with corresponding symbols in the second band bit stream; and
means for processing the combined symbols to yield the portion of the input bit stream.

22. The system of claim 21, wherein the transmitter is configured to map the portion of the input bit stream to the second band responsive to an error detection signal and wherein the system further comprises:
means for detecting errors in the first band; and
means for generating the error detection signal for receipt by the transmitter responsive to the detected errors.

23. A computer readable carrier including software that is configured to control a computer to implement a multi-band ultra wideband signal processing method embodied in a computer readable medium to improve error rates in the transmission of a data stream to a receiver, the method including the steps of:
mapping a bit stream within the data stream to a first band of the multiple bands;
mapping the bit stream to a second band of the multiple bands, wherein the first and second bands are non-overlapping; and
transmitting the bit stream in the first band and the bit stream in the second band for receipt by the receiver.

24. The computer readable carrier of claim 23, wherein the method implemented by the computer further includes the step of:
receiving a received error indicator corresponding to the bit stream in the first band, wherein the bit stream is mapped to the second band and transmitted in the second band only responsive to receipt of the received error indicator.

25. A computer readable carrier including software that is configured to control a computer to implement a multi-band ultra wideband signal processing method embodied in a computer readable medium to improve error rates in a data stream received from a transmitter, the transmitter capable of mapping a portion of an input bit stream of a data stream to a first band of the multiple bands and the portion of the input bit stream to a second band of the multiple bands, the processing method including the steps of:
receiving a bit stream in the first band and an other bit stream in the second band, the received bit streams corresponding to the portion of the input bit stream;
demapping the first band including the received bit stream to obtain a first band bit stream corresponding to the input bit stream;
demapping the second band including the other bit stream to obtain a second band bit stream corresponding to the second bit stream; and
processing the first and second band bit streams to yield the portion of the input bit stream.

26. The computer readable carrier of claim 25, wherein the processing step for implementation by the computer comprises the steps of:
combining symbols in the first band bit stream with corresponding symbols in the second band bit stream; and
processing the combined symbols to yield the portion of the input bit stream.

27. The computer readable carrier of claim 26, wherein the transmitter is configured to map the portion of the input bit stream to the second band responsive to an error detection signal and wherein the method implemented by the computer further includes the step of:
detecting errors in the first band; and
generating the error detection signal for receipt by the transmitter responsive to the detected errors.
